(19) United States
(12) Patent Application Publication
(10) Pub. No.: US 2011/0195753 A1
(43) Pub. Date: Aug. 11, 2011

(54) Smartphone Case with LEDS

(76) Inventors: Jason Mock, Clermont, FL (US); Kimberly Mock, Clermont, FL (US)

(21) Appl. No.: 13/025,895

(22) Filed: Feb. 11, 2011

Related U.S. Application Data
(60) Provisional application No. 61/303,576, filed on Feb. 11, 2010.

(51) Int. Cl. H04W 88/02

(52) U.S. Cl. 455/566; 455/575.1; 455/572; 455/567

(57) ABSTRACT

A smartphone case with LEDS is disclosed. In a particular embodiment, the case includes a front portion adapted to cradle a lower portion of a smartphone, a rear portion adapted to engagingly mate with the front portion to secure the smartphone within the case, a first strip of LEDS and a second strip of LEDS are mounted on opposing sides of the front portion, a vibrating sensor is adapted to activate the LEDS of the case when a vibrator of the smartphone is vibrating, and circuitry is used to control the vibrating sensor and the LEDS. The vibrating sensor detects vibrations of the vibrator of the smartphone when the smartphone is receiving an incoming call or message. The LEDS are programmed to display in a set sequence when activated, where the set sequence to display the LEDS is selected by a user.

### I. CROSS-REFERENCE TO RELATED APPLICATIONS

This application claims the benefit of U.S. Provisional Application No. 61/303,576 filed Feb. 11, 2010. The disclosure of the provisional application is incorporated herein by reference.

### II. FIELD OF THE DISCLOSURE

The present disclosure is generally related to a smartphone case with light emitting diodes (LEDS).

### III. BACKGROUND

Smartphones are the fastest growing segment of the entire wireless market and combine the features of a personal digital assistant and a cell phone. The Apple iPhone and other smartphones are popular devices, but they are also expensive. Accordingly, many types of cases have been developed to protect a smartphone from bumps, drops, scratches, and rough handling. For example, cases may be from materials such as leather, aluminum, or plastic. A shortcoming of these cases is that the cases do not add functionality or communicate with the smartphone to avoid missed calls or messages. Accordingly, what is needed in the art is a smartphone case that has the ability to increase the functionality of the smartphone and to capture the user's attention.

Another need exists in the art for an improved smartphone case that is adaptable to provide a light display that is selected by the user.

Another need exists in the art for an improved smartphone case that is customized to a particular color.

However, in view of the prior art at the time the present invention was made, it was not obvious to those of ordinary skill in the pertinent art how the identified needs could be fulfilled.

It is, therefore, to the effective resolution of the aforementioned problems and shortcomings of the prior art that the present invention is directed.

### IV. SUMMARY

In a particular embodiment, a smartphone case with LEDS is disclosed. The case includes a front portion, a rear portion adapted to engagingly mate with the front portion to secure a smartphone within the case, and a plurality of light emitting diodes (LEDS) mounted about a periphery of the front portion. The first portion also includes a cradle to secure a lower portion of the smartphone. In addition, the case includes a vibrating sensor adapted to activate the LEDS lights of the case when a vibrator of the smartphone is vibrating and the plurality of LEDS are programmed to display in a set sequence when activated. A battery box of the case is used to house a battery, where the battery powers the LEDS and circuitry that controls the vibrating sensor and the LEDS. The set sequence to display the plurality of LEDS may be selected by a user using a control button to select the set sequence and to turn the case off and on. The plurality of LEDS may include a first strip of LEDS and a second strip of LEDS that are mounted on opposing interior sides of the front portion. A plurality of apertures on the opposing sides of the front portion are each configured for receiving an LED, so that the LEDS are viewable on an exterior sides of the front portion.

In another particular embodiment, the case includes a front portion adapted to cradle a lower portion of a smartphone, a rear portion adapted to engagingly mate with the front portion to secure the smartphone within the case, a first strip of LEDS and a second strip of LEDS mounted on opposing sides of the front portion, a vibrating sensor adapted to activate the LEDS of the case when a vibrator of the smartphone is vibrating, and circuitry to control the vibrating sensor and the LEDS. In addition, the LEDS are programmed to display in a set sequence when activated, which is selected by a user and a control button is used to select the set sequence and to turn the case off and on. The vibrating sensor of the case detects vibrations of the vibrator of the smartphone when the smartphone is receiving an incoming call or message, and the sensor activates the LEDS.

In another embodiment, the case includes a plurality of light emitting diodes (LEDS) mounted about a periphery of the case, and a vibrating sensor adapted to activate the LEDS of the case when a vibrator of a smartphone secured within the case is vibrating.

Accordingly, an advantage of the smartphone with LEDS is to silently indicate to a user of an incoming call or message and give the user a visual display of lights to prevent a missed call or message.

Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

For a fuller understanding of the nature and objects of the invention, reference should be made to the following detailed description, taken in connection with the accompanying drawings, in which:

FIG. 1 is a front view of a particular embodiment of a smartphone case with LEDS;

FIG. 2 is a rear view of the smartphone case with LEDS of FIG. 1;

FIG. 3 is a right elevational view of the smartphone case with LEDS;

FIG. 4 is a top view of the smartphone case with LEDS;

FIG. 5 is a bottom view of the smartphone case with LEDS;

FIG. 6 is a left elevational view of the smartphone case with LEDS;

FIG. 7 is a rear perspective view of the smartphone case with LEDS;

FIG. 8 is a rear perspective view of the smartphone case showing the first portion and the second portion separated; and

FIG. 9 is a rear exploded view of the smartphone case showing the LEDS lights, battery, vibrating sensor and circuitry.

### VI. DETAILED DESCRIPTION

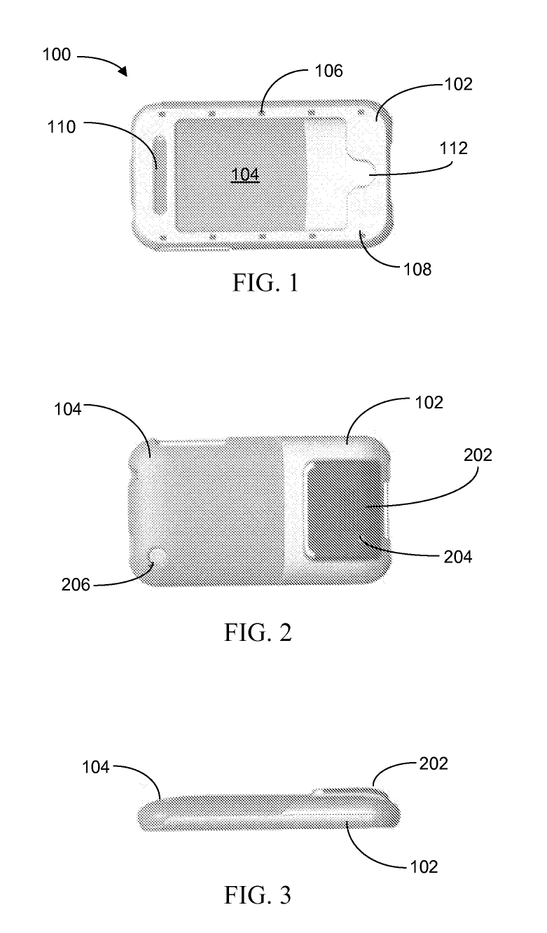

Referring to FIG. 1, a particular illustrative embodiment of a smartphone case with LEDS is disclosed and generally designated 100. The case 100 includes a first portion 102 and a second portion 104. The first portion 102 includes a plurality of apertures 106, 108 on opposing sides. The LEDS are viewable from the exterior surface of the case 100. For example, LEDS may be mounted to an interior surface of the first portion 102 of the case 100, where the LEDS are viewable through the apertures 106, 108 on opposing sides of the case 100. The first portion 102 is adapted to fit snugly around a smartphone and has generally a rectangular cutout to view a display of the smartphone. In addition, a circular cutout 112 may be disposed along an edge of the rectangular cutout so that a control button of the smartphone can be accessed even when the smartphone is within the case 100.

The smartphone case is compatible with smartphones such as the iPhone, Blackberry, etc. The case 100 features a vibrating sensor that activates LED lights when the smartphone receives an incoming call or message. The LED lights are programmed and display in a set sequence that can be changed by pressing a button on the case 100. The case 100 may be comprised of a hard plastic material that may be any of several different colors and combinations. The case 100 includes two portions or sections. The first portion 102 includes the LEDS lights or light source, a battery box to house the batteries, circuitry to connect the light source to the batteries as well as the vibrating sensor, and an on/off switch that also may serve as the button to change the light source display sequence. The second portion 104 is the back of the case 100 that fits on top of the smartphone by sliding the smartphone into the second portion 104. To engage the first portion 102 with the second portion 104, the second portion 104 with the smartphone device inserted is slid into the first portion to secure the case 100 around the smartphone.

The second portion 104 of the case 100 is visible in FIG. 2, which shows a battery cover 202 and a selective control button 204 of the case 100. The selective control button 204 may be used to select the set sequence of the LEDS and to turn the case off and on. A circular camera cutout 206 is disposed within a rear surface of the first portion 102, where the camera cutout 206 is configured to allow access for the smartphone camera lens secured within the case 100.

Referring now to FIG. 3, the first portion 102 and the second portion 104 are engagingly mated together. The rear of the first portion 102 includes a battery box that houses the battery, circuitry and vibrating sensor, which is all accessible through a battery cover 202.

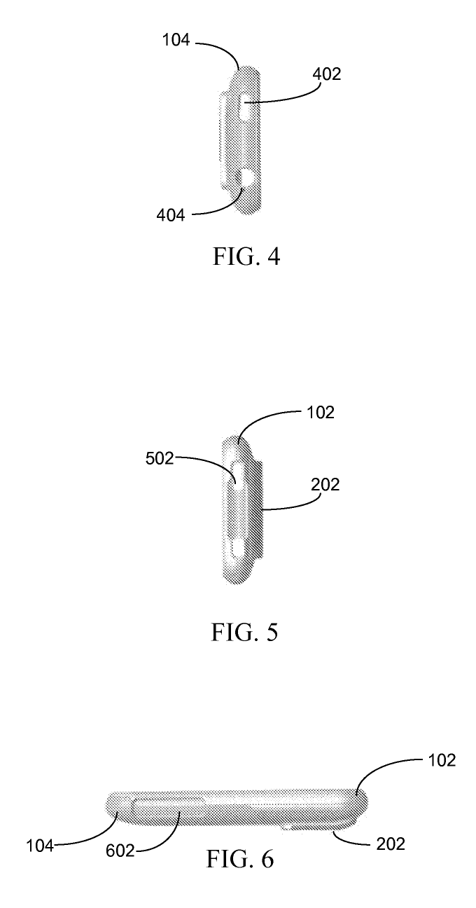

The top of the first portion 102, which is secured around a top part of the smartphone, includes a smartphone on/off cutout 402 so that a user can access the smartphone's on/off button as illustrated in FIG. 4. An earpiece cutout 404 is also disposed on the top of the first portion 102 so that an earpiece or headphones may be plugged into the smartphone secured within the case 100. As illustrated in FIG. 5, a slot 502 is disposed on a bottom of the first portion 102 so that a docking plug of the smartphone can be accessed even when the smartphone is within the case 100.

Referring now to FIG. 6, a volume slot 602 is disposed partially in a sidewall of the first portion 102 and the second portion 104. The volume slot 602 allows a user to access a volume and/or vibrate function of the smartphone within the case 100.

FIG. 7 illustrates a rear perspective view of the smartphone case with LEDS 100. As explained above, the circular camera cutout 206 is disposed within the rear surface of the first portion 102, where the camera cutout 206 is configured to allow access for the smartphone camera lens secured within the case 100. The battery cover 202 is secured over the battery box formed in the rear of the first portion 102. The selective control button 204 of the case 100 is used to select the set sequence of the LEDS display and to turn the case off and on. In addition, the set sequence of the LEDS may be determined by the particular vibration pattern of the smartphone.

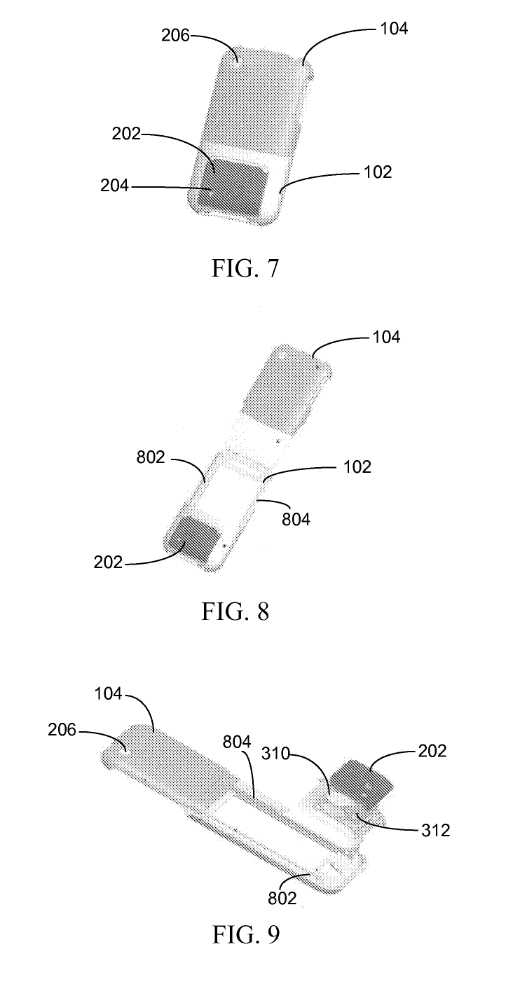

Referring now to FIG. 8, the second portion 104 is disengaged from the first portion 102. The smartphone is slid into the cradle of the first portion 102 and the second portion 104 is adapted to slide behind the rear of the smartphone to engage the first portion 102. A first strip of LEDS 802 is secured to the interior surface of a side of the first portion 102. Similarly, a second strip of LEDS 804 is secured to the interior surface of an opposing side of the first portion 102. The LEDS are aligned with apertures 106, 108 disposed on the front surface of the first portion 102. The battery cover 202 is removed from the battery box in FIG. 9. Accordingly, the battery 310 and vibrating sensor 312 is illustrated, where the vibrating sensor 312 and circuitry is in electrical communication with the first strip 802 and the second strip 804 of LEDS. The LED lights 802, 804 or light source can be changed with different colors as well as the color of the case 100.

In operation, once the smartphone is in the case 100 and set to vibrate mode when receiving calls, the case 100 is functional. When the smartphone receives a phone call (or message) and vibrates, it activates the vibrating sensor 312, which is powered by the battery supply 310. Once the vibrating sensor 312 is activated, it then activates the LEDS 802, 804 or light source that is connected to the battery supply 310, which will display the lights 802, 804 in a set light sequence. This alerts the user of the incoming call or message and gives the user a visual display of lights to acknowledge the incoming call and to prevent a missed call. By pressing the selective control button 204, the case may be turned on and off by pressing and holding the button 204 or pressing it numerous times to change the light sequence display to the pre-set sequences.

A mold may be created of the case design and a hard plastic material may be used to mold the case 100. Once the case 100 is completed, the components may be added into the case 100 such as the circuitry connecting the LEDS or light source to the battery supply 310, which is housed on the rear of the first portion 102. The case 100 color and LEDS 802, 804 color can also be changed.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.52(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A smartphone case with LEDS, the case comprising:
a front portion;
a rear portion adapted to engagingly mate with the front portion to secure a smartphone within the case; and
a plurality of light emitting diodes (LEDS) mounted about a periphery of the front portion.

2. The smartphone case of claim 1, further comprising a vibrating sensor adapted to activate the LEDS lights of the case when a vibrator of the smartphone is vibrating.

3. The smartphone case of claim 2, wherein the plurality of LEDS are programmed to display in a set sequence when activated.

4. The smartphone case of claim 3, further comprising a battery box to house a battery.

5. The smartphone case of claim 4, further comprising circuitry to control the battery, vibrating sensor and the LEDS.

6. The smartphone case of claim 5, wherein the set sequence to display the plurality of LEDS is selected by a user.

7. The smartphone case of claim 6, wherein the first portion further comprising a cradle to secure a lower portion of the smartphone.

8. The smartphone case of claim 7, further comprising a control button to select the set sequence and to turn the case off and on.

9. The smartphone case of claim 8, wherein the vibrator of the smartphone vibrates when receiving an incoming call or message.

10. The smartphone case of claim 9, wherein the plurality of LEDS further comprising a first strip of LEDS and a second strip of LEDS mounted on opposing interior sides of the front portion.

11. The smartphone case of claim 10, wherein the front portion further comprising a plurality of apertures on the opposing sides of the front portion each configured for receiving an LED viewable on an exterior side of the front portion.

12. A smartphone case with LEDS, the case comprising:
a front portion adapted to cradle a lower portion of a smartphone;
a rear portion adapted to engagingly mate with the front portion to secure the smartphone within the case;
a first strip of LEDS and a second strip of LEDS mounted on opposing sides of the front portion;
a vibrating sensor adapted to activate the LEDS of the case when a vibrator of the smartphone is vibrating; and
circuitry to control the vibrating sensor and the LEDS.

13. The smartphone case of claim 12, wherein the LEDS are programmed to display in a set sequence when activated.

14. The smartphone case of claim 13, further comprising a battery box to house a battery.

15. The smartphone case of claim 14, wherein the set sequence to display the LEDS is selected by a user.

16. The smartphone case of claim 15, wherein the first portion further comprising a cradle to secure a lower portion of the smartphone.

17. The smartphone case of claim 16, further comprising a control button to select the set sequence and to turn the case off and on.

18. The smartphone case of claim 17, wherein the vibrating sensor detects vibrations of the vibrator of the smartphone when the smartphone is receiving an incoming call or message.

19. A smartphone case with LEDS, the case comprising:
a plurality of light emitting diodes (LEDS) mounted about a periphery of the case; and
a vibrating sensor adapted to activate the LEDS of the case when a vibrator of a smartphone secured within the case is vibrating.

20. The smartphone case of claim 19, wherein the vibrator of the smartphone vibrates when receiving an incoming call or message.
